(19) United States
(12) Patent Application Publication
(10) Pub. No.: US 2012/0075152 A1
(43) Pub. Date: Mar. 29, 2012

(54) Display Device

(76) Inventors: Hideyuki Usui, Kanagawa (JP); Daisuke Nozue, Kanagawa (JP)

(21) Appl. No.: 13/248,303

(22) Filed: Sep. 29, 2011

(30) Foreign Application Priority Data
Sep. 29, 2010 (JP) 2010-0219746

(51) Int. Cl. H01Q 1/22

(52) U.S. Cl. 343/720

(57) ABSTRACT

A display device includes a flat-panel display, a metal plate, and an antenna device. The flat-panel display portion is positioned on an upper surface of display device. The metal plate is positioned on the flat-panel display portion along an front edge of the upper surface. The antenna device for a wireless LAN is positioned on the upper surface of the flat-panel display portion.

### CROSS-REFERENCE TO RELATED APPLICATION

This application claims the benefit and priority of Japanese Patent Application No. 2010-219746 filed on Sep. 29, 2010 before the State Intellectual Property Office of Japan, the disclosure of which is incorporated herein by reference.

### FIELD OF THE INVENTION

The present invention relates to a display device and in particular to a display device having an antenna device for a wireless LAN comprising multiple antennas.

### BACKGROUND

In recent years, there is an increasing demand for utilizing a wireless Local Area Network (LAN) in equipments, such as a flat TV set with a display device, a Personal Computer (PC), and a notebook PC. High-speed data communication, required to increase the speed several in the wireless LAN, includes a technology called as Multiple Input Multiple Output (MIMO) adopted by the wireless LAN standard “IEEE 802.11n”.

The MIMO is a wireless communication technology in which multiple antennas are combined to expand a bandwidth for data communication. The antennas simultaneously transmit different data and they are synthesized upon reception, thus artificially implementing broadband for high speed communication.

For the MIMO to use in the aforementioned display device, it needs, for example, to install multiple antennas with a flat-panel display portion of the display device. The flat-panel display portion is configured to have a substantially rectangular shape. For example, it is common to provide a metal plate on upper and lower surfaces and on both sides thereof, to improve a mechanical strength of the flat-panel display portion.

A n example the MIMO technology being applied is disclosed in U.S. Patent Publication No. 2011/0122039, teaching a known antenna device (for example, one shown in FIG. 11) that maintains isolation between antennas of two wireless devices and can transmit and receive a signal in all directions with no null point in a horizontal plane in a communication apparatus installing two wireless devices using close frequency bands.

A known antenna device 101 shown in FIG. 11 includes a first dipole antenna 102 and a second dipole antenna 103 positioned on both sides of an upper end of a substrate 104.

The first dipole antenna 102 is composed of radiation elements 102a, 102b symmetrically positioned with respect to a feeding point 105 as the center. The feeding point 105 is connected through a coaxial cable 106 to a radio circuit (not shown) mounted on the substrate. An external conductor of the coaxial cable 106 is connected to ground patterns 107 fabricated on the substrate.

The second dipole antenna 103 is composed of radiation elements 103a,103b symmetrically positioned with respect to a feeding point 108 as the center. The feeding point 108 is connected through a coaxial cable 109 to a radio circuit (not shown) mounted on the substrate. An external conductor of a coaxial cable 109 is connected to the ground pattern 107 fabricated on the substrate 104.

The radiation elements 102a, 102b of the first dipole antenna 102 and the radiation elements 103a, 103b of the second dipole antenna 103 are positioned in a positional relation orthogonal to each other in an XZ plane. Further, the radiation elements 102a, 102b of the first dipole antenna 102 are positioned, inclined, at an angle (45° in the example shown FIG. 11) larger than 0° and smaller than 90°, from a Z-axis direction to an X-axis direction in the XZ plane.

In the antenna equipment 101, since the radiation elements 102a,102b and the radiation elements 103a,103b are positioned in the positional relation orthogonal to each other in the XZ plane, a polarized wave radiated from the two dipole antennas 102,103 will result in crossing each other at right angles. Although the two dipole antennas 102,103 are oppositely positioned in contiguity with each other, coupling caused by theses radiation waves can be decreased, thereby providing large isolation.

By the way, the conventional antenna device 101 shown in FIG. 11 was not developed for use in a display device.

Such being the case, provided that the conventional antenna device 101 shown in FIG. 11 is mounted, for example, on a surface either of the flat-display panel portion in which the metal plate is provided on the upper and lower surfaces and the both sides, radio waves radiated from the radiation elements 102a, 102b and the radiation elements 103a, 103b might be affected by the metal plate.

### SUMMARY

An object of the present invention, inter alia, is to provide a display device with an antenna device for a wireless LAN, comprising multiple antennas, which is capable of radiating radio waves further away, without being affected by the metal plate provided in the flat-panel display portion or metal body positioned around the display device.

The display device according to the invention includes a flat-panel display, a metal plate, and an antenna device. The flat-panel display portion is positioned on an upper surface of display device. The metal plate is positioned on the flat-panel display portion along an front edge of the upper surface. The antenna device for a wireless LAN is positioned on the upper surface of the flat-panel display portion.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view of a display device according to the invention;

FIG. 2 is a front view of the display device shown in FIG. 1;

FIG. 3 is a left side view of the display device shown in FIG. 1;

FIG. 4 is a perspective view of an antenna device used for the display device shown in FIG. 1;

FIG. 5A is a plan view of the antenna device shown in FIG. 4;

FIG. 5B is a front view of the antenna device shown in FIG. 4;

FIG. 6A is a right side view of the antenna device shown in FIG. 4;

FIG. 6B is a left side view of the antenna device shown in FIG. 4;

FIG. 6A is a rear view of the antenna device shown in FIG. 4;

FIG. 7 is a plan view schematically showing the a trial display device having a pair of antennas positioned on both sides of an upper surface of a flat-panel display portion;

FIG. 8 is a graphical representation showing measurement results of transmission performance of a high frequency signal obtained by a network analyzer between the antennas adjacent to each other in the trial display device shown in FIG. 7;

FIG. 9 is an explanatory diagram showing a positional relationship between a pair of antennas positioned on both sides of the upper surface of the flat-panel display portion and a wireless LAN module provided inside the trial display device;

FIG. 10A is a plan view schematically a pair of antennas positioned between a front and rear edge of a flat-panel display portion;

FIG. 10A is a plan view schematically a pair of antennas positioned along the rear edge of the flat-panel display portion; and

FIG. 11 is a perspective view of a known antenna device.

### DETAILED DESCRIPTION OF THE EMBODIMENT(S)

Hereinafter, a description will be made to an embodiment of the present invention with reference to the accompanying drawings.

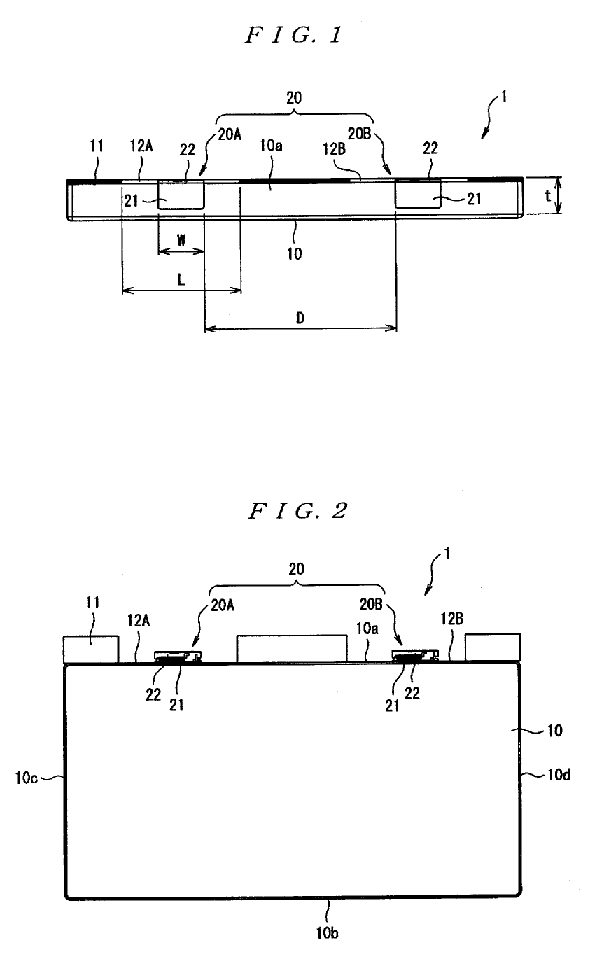

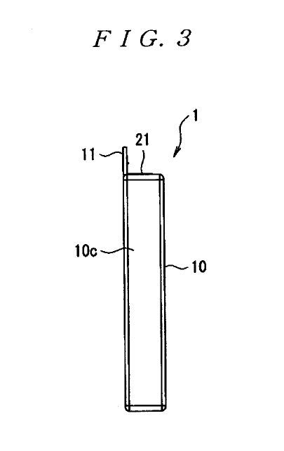

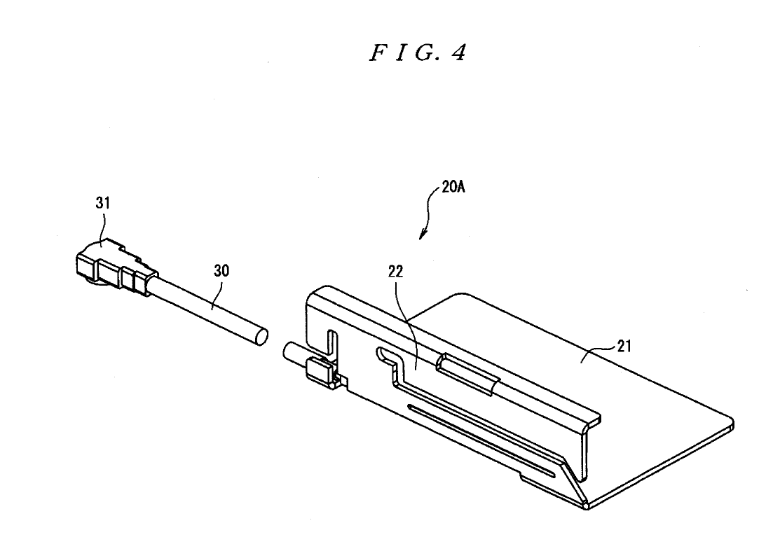

A display device 1 shown in FIG. 1 to FIG. 3 is applied to a flat TV set and is available itself of a Multiple Input and Multiple Output (MIMO), which has been adopted by the wireless LAN standard “IEEE 802.11n”.

Here, the display device 1 includes a flat-panel display portion 10 and an antenna device 20 for a wireless LAN.

The flat-panel display portion 10 has a substantially rectangular shape in the embodiment shown, having thickness t in a depth direction (upper and lower direction in FIG. 1), with an upper surface 10a, a lower surface 10b, and left and right both sides 10c. At a front end edge (upper end edge in FIG. 1) in the depth direction of the upper surface 10a of the flat-panel display portion 10, a linearly extending metal plate 11 is positioned along the front end edge. The metal plate 11, protruding upward from the upper surface 10a of the flat-panel display portion 10, is made of a rectangular flat panel. On the metal panel 11, a plurality of apertures 12A,12B (two in the shown embodiment) are formed at positions corresponding to each antenna 20A, 20B to be discussed later.

The antenna device 20 includes a plurality of antennas 20A, 20B (two in the shown embodiment). As shown in FIG. 1, the multiple antennas 20A, 20B are positioned side by side on the same straight line and are arranged in parallel with the metal plate 11. The multiple antennas 20A, 20B are positioned apart from each other at a predetermined distance D.

The predetermined distance D is a distance among the adjacent antennas 20A, 20B where ratio (voltage standing wave ratio: VSWR) of a predetermined voltage at an output side to a predetermined voltage at an input side is below −20 dB, when a high frequency signal having a predetermined voltage is input from one antenna and the predetermined voltage is derived thereby from the other antenna.

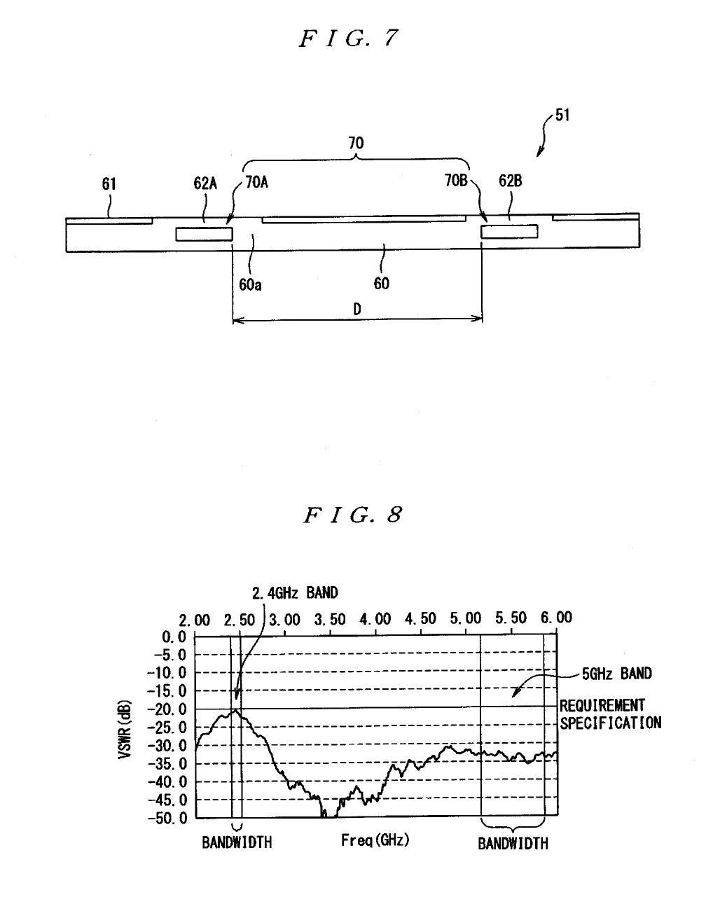

To verify the predetermined distance D, a transmission performance of the high frequency signal between the adjoined antennas is measured in a trial display device shown in FIG. 7 using the network analyzer.

In concrete terms, the trial display device 51 shown in FIG. 7 includes an antenna device 70 for a wireless LAN on an upper surface 60a of a flat-panel display portion 60. At the front end edge (upper end edge in FIG. 7) in the depth direction of the upper surface 60a of the flat-panel display portion 60, a linearly extending metal plate 61 is provided along the front end edge. The antenna device 70 includes a pair of antennas 70A,70B aligned on a straight line in parallel with the metal plate 61. Spacing between the pair of the antennas 70A,70B is set to a predetermined distance D of which length is determined to be approximately 120 mm. Apertures 62A,62B are formed at positions corresponding to each antenna 70A,70B on the metal plate 61. The pair of antennas 70A,70B are positioned at the center in the depth direction of the upper surface 60a of the flat-panel display portion 60 away from the metal plate 61.

In the trial display device 51 shown in FIG. 7, a network analyzer (not shown) is utilized to input a high frequency signal (ranging from about 2.00 GHz to 6.00 GHz) having a predetermined voltage from one of the pair of the antennas 70A,70B. At that time, the predetermined voltage is derived from the other adjacent antennas 70A,70B and a ratio (voltage standing wave ratio: VSWR) of the predetermined voltage at the output side to that at the input side is measured. The Results thus obtained are shown in FIG. 8.

As shown in FIG. 8, where the predetermined distance D between the pair of the antennas 70A,70B is approximately 120 mm, it can be seen that the ratio (voltage standing wave ratio: VSWR) of the predetermined voltage at the output side to that at the input side is −20 dB that is a requirement specification, even in the high frequency signal of both 2.4 GHz band and 5 GHz band used for the wireless LAN. Gradually lengthening the predetermined distance D between the pair of the antennas 70a,70B more than 120 mm drops the voltage standing wave ratio (VSWR) proportionately to the distance. In the present invention, the antennas 70A,70B are arranged such that the predetermined distance D becomes shorter.

An explanation will then be made only to a configuration of the antenna 20A, as the multiple antennas 20A, 20B have the identical configuration composing the antenna device 20 for the wireless LAN.

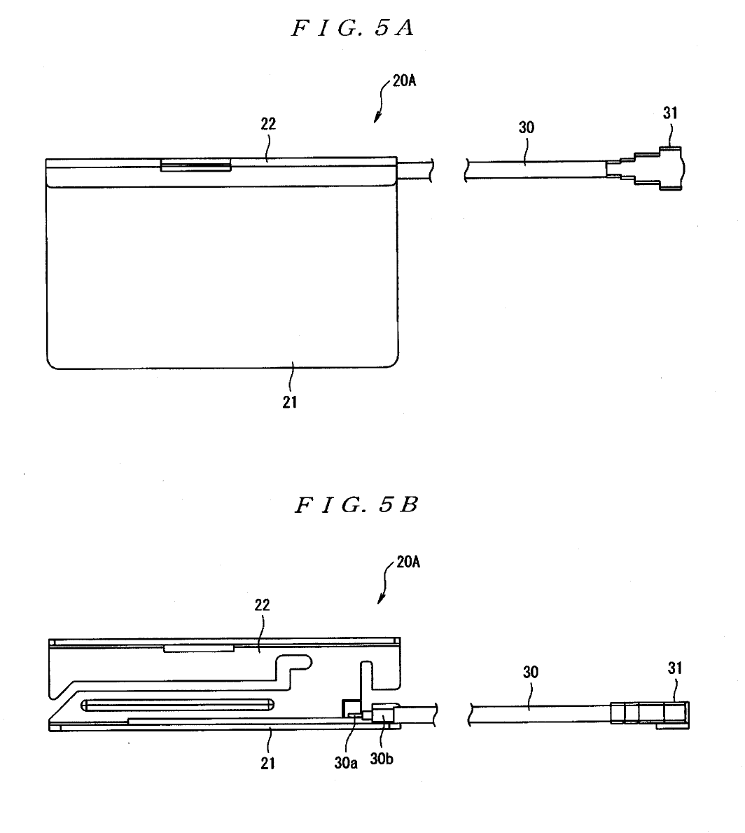

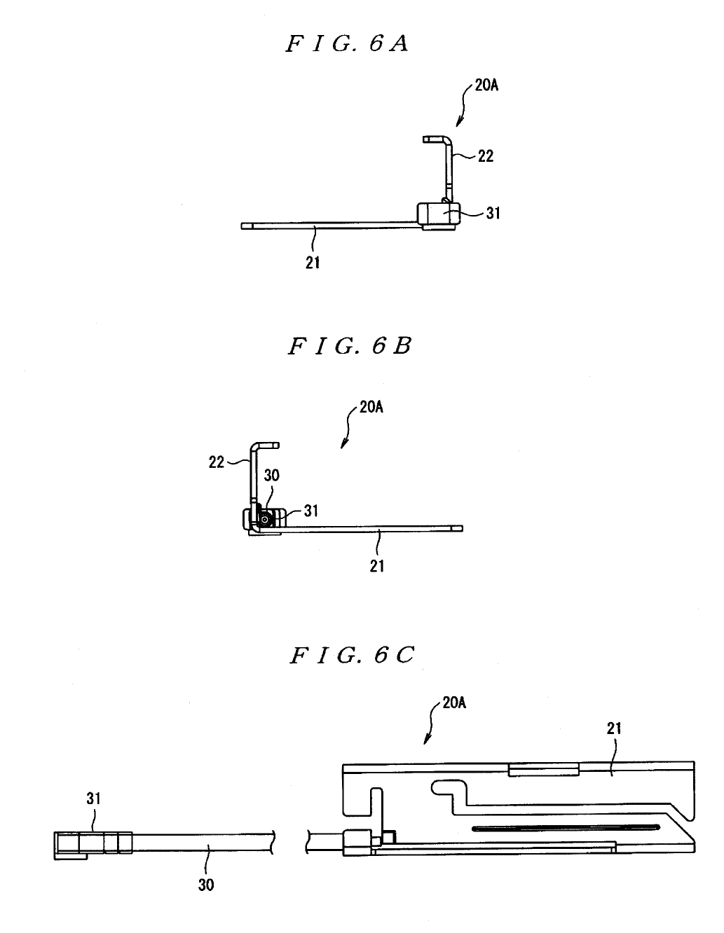

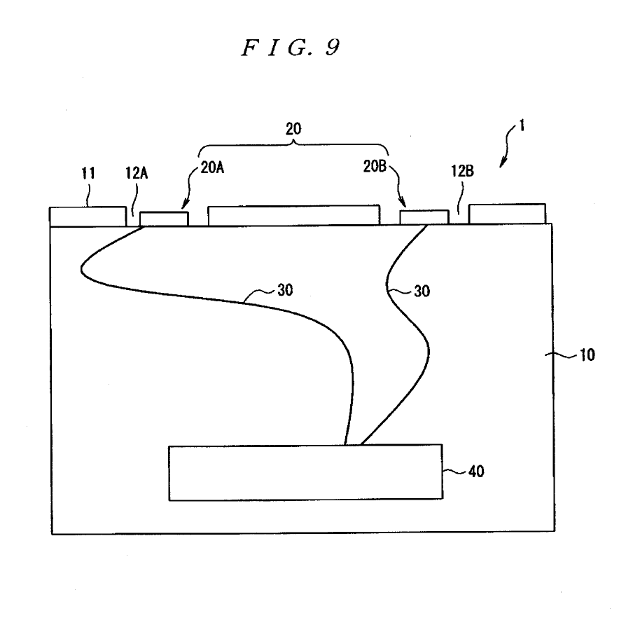

The antenna 20A is, so-called, an inverted F antenna, and includes a rectangular and tabular ground plate 21 and a tabular radiation elements 22 rising up from one side edge of a ground plate 21, as shown in FIG. 4 to FIG. 6. The antenna 20A is made by stamping and forming the metal plate. As best shown in FIG. 5B, a core conductor 30a of a coaxial cable 30 is soldered to the radiation elements 22, and a braid 30b is soldered to the ground plate 21. As shown in FIG. 9, the coaxial cable 30 is connected to a wireless LAN module 40 to control MIMO communication.

Here, as shown in FIG. 1, the multiple antennas 20A, 20B are arranged on the upper surface 10a of the flat-panel display portion 10 so that the radiation elements 22 face the apertures 12A,12B formed in the metal plate 11, and are arranged on the same straight line with the metal plate 11. That is, the multiple antennas 20A, 20B are arranged so that each radiation element 22 is positioned inside the apertures 12A,12B formed in the metal plate 11, and is along the front end edge in the depth direction of the upper surface 10a of the flat-panel display portion 10.

In the shown embodiment, the width L of each aperture 12A,12B is set to be approximately 65 mm, the width W of each antenna 20A, 20B is set to be approximately 25 mm, and a distance of the both sides of the antenna 20A, 20B is set to be approximately 20 mm. As shown in FIG. 1, the radiation elements 22 of each antenna 20A, 20B are arranged on the same straight line with the metal plate 11, the width L of each aperture 12A,12B just has to be approximately 65 mm, when the width W of each antenna 20A, 20B is approximately 25 mm.

A cover member (not shown) covers around the flat-panel display portion 10 with the antenna device 20 for the wireless LAN.

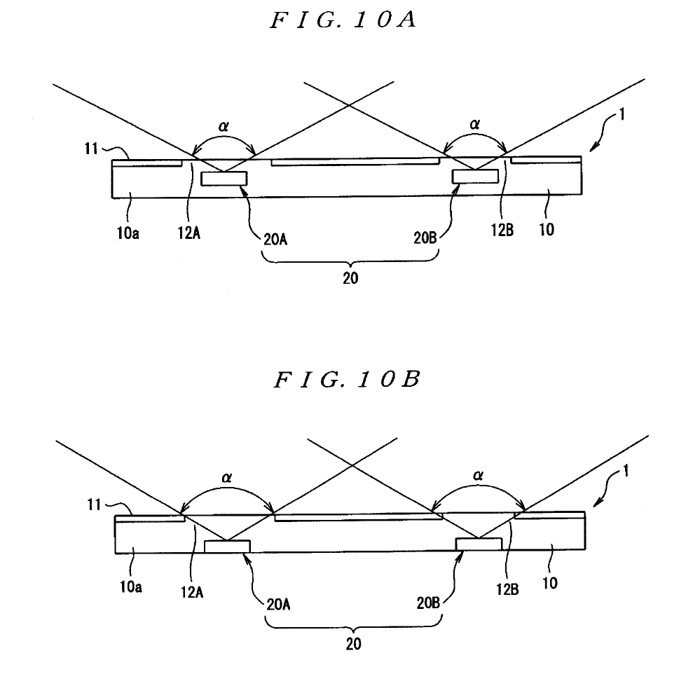

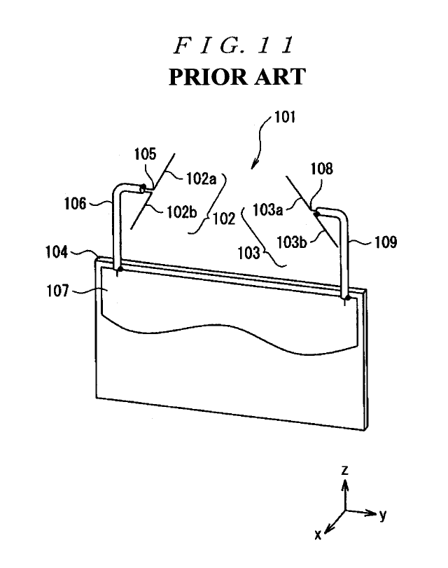

In the display device 1 having such a configuration, when sending the MIMO, a high frequency radio wave having either 2.4 GHz band or 5 GHz band is radiated from the both antennas 20A, 20B. More specifically, the high frequency radio wave having either 2.4 GHz band or 5 GHz band is radiated from the radiation elements 22 of the both antennas 20A, 20B, toward an access point (not shown) positioned at the forward side (upper side in FIG. 1) of the display device, at a radiation angle of a (see FIG. 10A and FIG. 10B). Further, when receiving the MIMO, the high frequency radio wave having either 2.4 GHz band or 5 GHz band radiated from the access point is received by the both antennas 20A, 20B.

In this instance, the arrangement of the antenna device 20 for the wireless LAN on the upper surface 10A of the flat-panel display portion 10 allows radiation of radio waves far away, without being affected by the metal body placed around the display device 1. Conversely, where the antenna device 20 for the wireless LAN is arranged on the lower surface 10b of the flat-panel display portion 10, when the metal body is used in a pedestal (not shown) on which the flat-panel display portion 10 is mounted, the antenna device is susceptible to influence from the metal body. What is more, where the antenna device 20 for the wireless LAN is arranged on the both sides 10c,10d of the flat-panel display portion 10, when the display device 1 is positioned at a vicinity of a wall on which the metal body is provided, the antenna device is susceptible to influence by the metal body. However, when the antenna device 20 for the wireless LAN is arranged on the upper surface 10a of the flat-panel display portion 10, such drawbacks will not emerge.

The antenna device 20 includes the multiple antennas 20A, 20B arranged side by side on the same straight line and arranged in parallel on the linearly extending metal plate that is positioned on the upper surface 10a of the flat-panel display portion 10. At a position corresponding to each antenna 20A, 20B of the metal plate 11, the plurality of apertures 12A,12B are formed. Therefore, radio waves radiated from each of the multiple antennas 20A, 20B are radiated through each aperture 12A,12B formed in the metal plate 11 provided in the flat-panel display portion 10. This radiates radio waves far away without being affected by the metal plate 11 positioned in the flat-panel display portion 10. Further, the provision of the metal plate 11 on the upper surface 10a of the flat-panel display portion 10 allows maintaining the mechanical strength of the flat-panel display portion 10.

Furthermore, as shown in FIG. 1, the multiple antennas 20A, 20B are positioned on the upper surface 10a of the flat-panel display portion 10 so that the radiation elements 22 face the apertures 12A,12B formed in the metal plate 11. For this reason, radio waves are smoothly radiated toward the access point through the apertures 12A,12B.

Moreover, as shown in FIG. 1, the multiple antennas 20A, 20B are arranged on the upper surface 10a of the flat-panel display portion 10 such that the radiation elements 22 are arranged on the same straight line with the metal plate 11. In other words, the multiple antennas 20A, 20B are each positioned so that each radiation element 22 thereof is positioned inside the apertures 12A,12B of the metal plate 11, as well as along the font edge end in the depth direction of the upper surface 10a of the flat-panel display portion 10. On that account, when radio wave are radiated from the radiation elements 22,22 of the both antennas 20A, 20B, the radio waves are radiated from the apertures 12A,12B, without being blocked by the metal plate 11, regardless of the degree of a radiation angle α of the radio waves, thus significantly mitigating an influence by the metal plate 11.

Since the multiple antennas 20A, 20B are positioned so that spacing between the adjacent antennas 20A, 20B is apart by a predetermined distance, coupling due to the radio waves radiated from each antenna 20A, 20B may be attenuated, thereby attaining large isolation. This enables communication without degradation of each antenna 20A, 20B.

As shown in FIG. 9, the two antennas 20A, 20B are respectively connected to the wireless LAN module 40 installed inside the display device 1 through the coaxial cable 30. In this way, the connection of the two antennas 20A, 20B to the wireless LAN module 40 through the coaxial cable 30 positioned the antennas 20A, 20B away from the wireless LAN module 40, thus mitigating significantly an influence by noises induced from the wireless LAN module 40.

While an exemplary embodiment of the present invention is described, this description is not limited thereto, and the present invention may be allowed for various modifications and improvements.

For example, the field to which the display device 1 is to be applied may be those with display devices such as a Personal Computer (PC) and a note book PC.

Alternatively, the multiple antennas 20A, 20B are not always limited to the case where the radiation elements 22 are arranged on the same straight line with the metal plate 11, they may be arranged so as to be off the straight line on which the metal plate 11 is standing. For instance, as shown in FIG. 10A, the multiple antennas 20A, 20B may be arranged on the center in the depth direction of the flat-panel display portion 10 away from the apertures 12A,12B formed in the metal plate 11, or, as shown in FIG. 10B, may be arranged on the rear end edge in the depth direction of the flat-panel display portion further away from the apertures 12A,12B formed in the metal plate 11.

In either case as shown in FIG. 10A or FIG. 10B, it is preferable to set the width of the apertures 12A,12B, for fear lest the radio waves radiated from each antenna 20A,20B do not influence with the metal plate 11.

Further, whereas in the shown embodiment, the description was made by giving the example where the antenna device 20 is composed of two antennas 20A, 20B, but should not limited thereto, and the antenna device 20 may be composed of three or more antennas.

Furthermore, the apertures positioned in the metal plate 11 corresponding to the each antenna. In the case where the antenna device 20 is composed of three or more antennas, there may be three or more apertures formed and corresponding to the number of antennas.

Moreover, each antenna 20A, 20B is not necessarily limited to the inverted F antenna, as long as they may be applied to the wireless LAN.

Even more, while in the instant specification, the predetermined distance between the antennas is set to the distance in which the VSWR goes below −20 dB, a value, beyond this, below −10 dB may be taken, for example.

What is claimed is:

1. A display device comprising:
a flat-panel display portion positioned on an upper surface of display device;
a metal plate positioned on the flat-panel display portion along an front edge of the upper surface; and
an antenna device for a wireless LAN positioned on the upper surface of the flat-panel display portion.

2. The display device according to claim 1, wherein the antenna device includes a plurality of antennas positioned side by side in parallel with the metal plate.

3. The display device according to claim 2, wherein the plurality of antennas are positioned a predetermined distance apart from each other.

4. The display device according to claim 3, further comprising a plurality of apertures positioned in the metal plate corresponding with the plurality of antennas.

5. The display device according to claim 4, wherein each of the plurality of antennas includes a tabular ground plate and a tabular radiation element extending up from an edge of the tabular ground plate.

6. The display device according to claim 5, wherein each of the plurality of antennas is positioned so that the tabular radiation element faces toward the one of the plurality of apertures in the metal plate.

7. The display device according to claim 5, wherein each of the plurality of antennas is arranged so that the tabular radiation element is positioned parallel and along a straight line running through the metal plate.
